(19) United States
(12) Patent Application Publication
(10) Pub. No.: US 2023/0086802 A1
(43) Pub. Date: Mar. 23, 2023

(54) ELIMINATING MEMORY BOTTLENECKS FOR DEPTHWISE CONVOLUTIONS

(71) Applicant: QUALCOMM Incorporated, San Diego, CA (US)

(72) Inventors: Sameer WADHWA, San Diego, CA (US); Suren MOHAN, San Diego, CA (US); Ren LI, San Diego, CA (US); Ankit SRIVASTAVA, San Diego, CA (US); Seyed Arash MIRHAJ, Poway, CA (US); Jian SHEN, San Diego, CA (US)

(21) Appl. No.: 17/478,609

(22) Filed: Sep. 17, 2021

(51) Int. Cl. G06F 7/50; G06F 3/06; G06F 7/523

(52) U.S. Cl. CPC G06F 7/50; G06F 3/0613; G06F 3/0659; G06F 3/0644; G06F 3/0673; G06F 3/0656; G06F 7/523

(57) ABSTRACT

Certain aspects of the present disclosure provide techniques for efficient depthwise convolution. A convolution is performed with a compute-in-memory (CIM) array to generate CIM output, and at least a portion of the CIM output corresponding to a first output data channel, of a plurality of output data channels in the CIM output, is written to a digital multiply-accumulate (DMAC) activation buffer. A patch of the CIM output is read from the DMAC activation buffer, and weight data is read from a DMAC weight buffer. Multiply-accumulate (MAC) operations are performed with the patch of CIM output and the weight data to generate a DMAC output.

### INTRODUCTION

Aspects of the present disclosure relate to machine learning, and more specifically, to efficient processing of depthwise convolutions to eliminate memory bottlenecks.

Depthwise-separable convolutions are a key feature in a wide variety of neural network architectures. This is especially true for models used in computer-vision applications. A depthwise-separable convolution generally involves one or more depthwise convolutions, as well as one or more pointwise convolutions. In some systems, the depthwise convolutions often require significantly fewer multiply-accumulators (MACs) to process data (as compared to pointwise convolutions), but they also generally require significant memory bandwidth.

For example, in many common neural network models, a depthwise convolution layer can be immediately preceded by a pointwise convolution layer (and is often followed by another pointwise operation). To process data using such a model, existing architectures generally process data for the pointwise layer and write the results to memory. The depthwise layer than retrieves these results from memory, and processes them to generate output from the depthwise layer.

Increasingly, compute-in-memory (CIM) circuits have been used to improve the latency and efficiency of convolution layers. However, such approaches still require reading and writing a significant amount of data to and from system memory (or on-chip memory) in order to perform a subsequent operation (e.g., using one or more MACs). This therefore requires a high memory bandwidth in order to prevent memory bottlenecks from harming the system efficiency and latency.

Accordingly, systems and methods are needed for alleviating these memory bottlenecks and providing more efficient depthwise convolutions.

### BRIEF SUMMARY

Certain aspects provide a method, comprising: performing a convolution with a compute-in-memory (CIM) array to generate CIM output; writing at least a portion of the CIM output corresponding to a first output data channel, of a plurality of output data channels in the CIM output, to a first digital multiply-accumulate (DMAC) activation buffer; reading a patch of the CIM output from the first DMAC activation buffer; reading weight data from a DMAC weight buffer; and performing multiply-accumulate (MAC) operations with the patch of CIM output and the weight data to generate a DMAC output.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example neural network architecture for performing depthwise convolutions in an efficient manner using near-CIM digital MACs and activation buffers.

FIG. 2 depicts an example system including a digital MAC engine configured to efficiently process data from a CIM using an activation buffer controlled by a controller.

FIG. 3 depicts an example process to efficiently read and write activation data, from a CIM, to and from an activation buffer in order to perform depthwise convolutions.

FIG. 4 is an example flow diagram illustrating a method for efficiently performing depthwise convolutions using near-CIM digital MAC engines.

FIG. 5 is an example flow diagram illustrating a method for efficiently performing depthwise convolutions.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for efficient performance of depthwise convolutions. In some aspects, these depthwise convolutions are performed as part of a bottleneck block, an expansion block, and/or a depthwise-separable convolution in a neural network. In an aspect, one or more digital MAC engines (also referred to as DMACs in the present disclosure) may be arranged in relative proximity to a CIM circuit (also referred to herein as a CIM array).

Each such DMAC includes an activation buffer that is used to buffer output from a preceding pointwise layer of the model. In some aspects, the pointwise layer is implemented by using a CIM array to process input data and output a corresponding tensor from the pointwise layer. Generally, the activation buffer may be selectively written to and read from in order to enable efficient depthwise computations, as discussed in more detail below.

Advantageously, by using such a DMAC with an activation buffer to perform the depthwise computations, the system can avoid excessive reading and writing the activation data to and from memory, thereby reducing the computational resources and latency introduced by the depthwise operation, which increases the efficiency of training and using the model. This is a significant improvement over existing systems that have either introduced significant latency to read and write to memory, have relied on expansive memories and wide memory busses to perform such depthwise convolutions, or both (each of which incurs area and power overhead).

The techniques and structures described herein can be used to improve the efficiency of processing data using a depthwise convolution layer of a neural network, both during inferencing (as data is received and passed through the model to generate new inferences), as well as during training (as training data is passed through the model during the training process).

### Example Neural Network Architecture for Performing Depthwise Convolutions

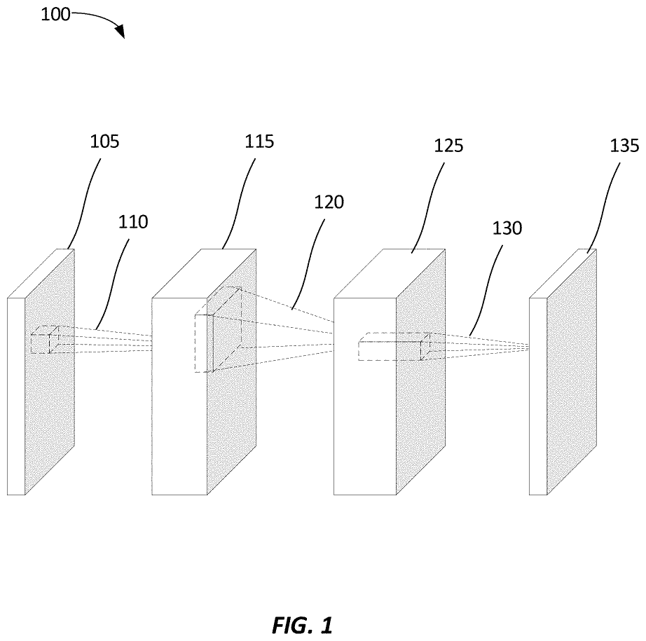

FIG. 1 depicts an example neural network architecture 100 for performing depthwise convolutions (e.g., as part of a depthwise-separable convolution operation) in an efficient manner using near-CIM digital MACs and activation buffers. In one aspect, the architecture 100 corresponds to an expansion block.

In the illustrated aspect, an input data tensor 105 is processed using a series of convolution operations to generate an output data tensor 135. Generally, the input and output data tensors 105 and 135 may be of any dimensionality. Typically, each tensor 105 and 135 is associated with a spatial dimensionality (often referred to as a height and width of the tensor), as well as some channel dimensionality (often referred to as the depth of the tensor). The input and output data tensors 105 and 135 may have matching or differing spatial dimensionality, and each may have one or more channels (with a matching channel depths or with differing channel depths).

In the illustrated architecture 100, a pointwise convolution operation (indicated by numeral 110) is used to process the input tensor 105, resulting in a tensor 115 with relatively more channels, as compared to the input tensor 105. Generally, the pointwise operation 110 includes processing the input tensor 105 using one or more pointwise kernels (e.g., 1×1×C kernels, where C is the number of channels in the tensor 105). These pointwise kernels are typically strided across the input tensor 105 to generate the tensor 115. In some aspects, the pointwise operation 110 is performed using a CIM array.

The resulting tensor 115 output by the pointwise operation 110 can then be processed using a depthwise convolution operation 120. The depthwise operation 120 generally includes processing the tensor 115 using one or more kernels. In some aspects, the kernels used in the depthwise convolution are referred to as depthwise kernels because they have a depth of one (e.g., K×K×1 kernels, where K indicates the spatial size (e.g., height and width) of the kernel). The depthwise operation 110 operates separately on each channel of data in the tensor 115 by striding depthwise kernel(s) across the tensor 115.

In aspects, the pointwise operation 110 can be performed efficiently using a CIM array or circuit (referred to in some aspects simply as a “CIM”), as the CIM can generally perform a large number of operations (e.g., multiply-accumulate operations) in parallel. This allows it to perform the pointwise operation 110 (which involve a large number of MAC operations) efficiently and rapidly (effectively performing all the MACs at once, in some aspects). That is, because pointwise convolutions operate across all channels of the input (and the input often has a very large number of channels), the number of multiplications needed is generally larger than the number needed for depthwise operations (which operate only on a single channel).

In an aspect, the relatively low number of MACs needed for a depthwise convolution operation 120 yields significant inefficiencies if mapped to CIM (e.g., because executing the relatively smaller number of MAC operations on a CIM would result in wasted power and hardware resources). That is, while pointwise operations (or other large kernel sizes) benefit from CIM architectures due to the ability amortize the fixed costs (such as quantizer power) over the large number of multiplications, smaller kernels (such as those used in depthwise convolutions) make this amortization inefficient.

In aspects of the present disclosure, therefore, the depthwise operation 120 is performed using one or more DMACs, as described in more detail below. In some aspects, the architecture 100 uses a separate DMAC for each channel of the tensor 115. Each DMAC generally includes an activation buffer that is used to temporarily store output data from the pointwise operation 110 (e.g., from the CIM). For example, for each CIM array operation (yielding some portion of the tensor 115), the DMAC can write the data elements to an activation buffer. These elements can then be selectively read from the activation buffer to perform a depthwise convolution.

Advantageously, the DMACs operations and use of an activation buffer, which may be pipelined behind the CIM array operations (e.g., executed temporally in a partially overlapping manner with the CIM operations), can obviate the need to write and read the tensor 115 to and from memory. This eliminates the memory bottleneck commonly found in existing systems.

In the illustrated architecture 100, the depthwise operation 120 results in a tensor 125, which is processed with another pointwise operation 130 to yield the output tensor 135. In some aspects, the pointwise operation 130 can similarly be performed using a CIM array.

### Example DMAC for Efficient Depthwise Convolutions

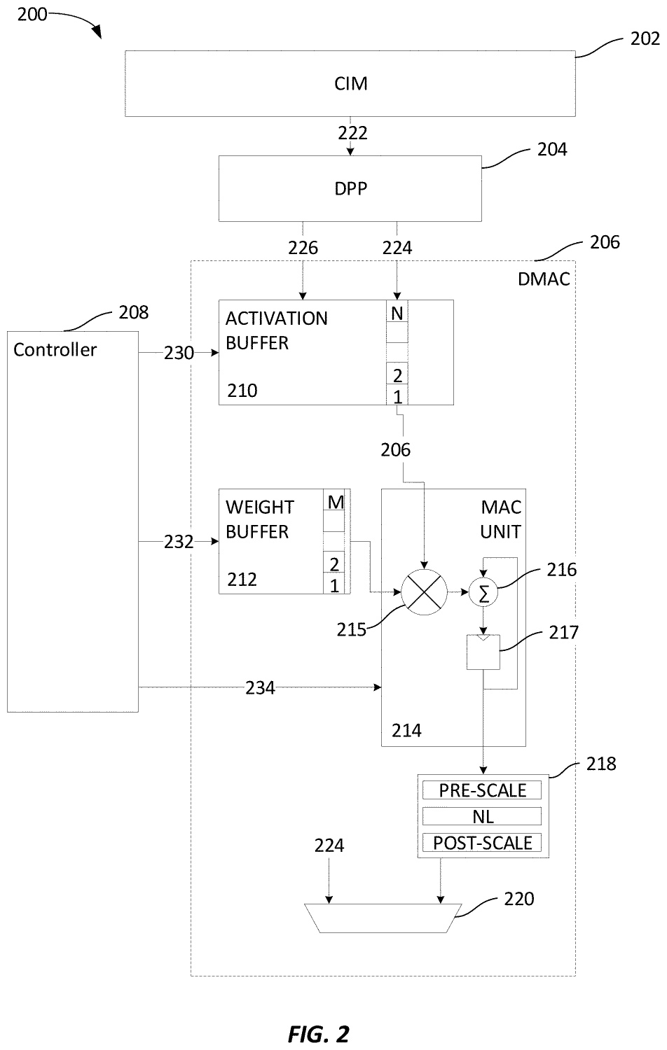

FIG. 2 depicts an example system 200 including a DMAC 206 configured to efficiently process data from a CIM using an activation buffer controlled by a controller.

In the illustrated architecture, a CIM 202 is used to perform a pointwise convolution operation. The output of the CIM 202 (indicated by arrow 222) is optionally received and processed by a digital processing pipeline (DPP) 204. The DPP 204 generally performs any preprocessing needed before passing it to the DMAC 206 (indicated by the arrow 224). For example, the DPP 204 perform normalization or non-linear function operations on the output from the CIM 202. Although illustrated as a digital pipeline, the DPP 204 (if present) may be implemented using other techniques, such as mixed-signal computing (which may be more power efficient in some aspects). The DPP 204 is an optional component, and in some aspects, the output of the CIM 202 can be directly provided to the DMAC 206.

In the illustrated architecture, the DMAC 206 is tightly coupled with the CIM 202. That is, there is a dedicated communications path from the CIM 202 to the DMAC 206, allowing for low latency and direct writing of data to an activation buffer 210. In the illustrated aspect, the activation buffer 210 is included within the DMAC 206, but in other aspects, the activation buffer 210 may reside in other locations or be part of other components. In aspects including multiple DMACs 206 (e.g., a separate DMAC for each channel of the output tensor generated by one or more CIMs), the system may similarly include a direct path from each of the one or more CIMs to the corresponding DMAC 206 for the output channel.

The results of the pointwise operation are written to an activation buffer 210. In one aspect, the activation buffer 210 is a relatively small buffer (e.g., 32 bytes) that stores a relatively small portion of the CIM output at any given time. Generally, the activation data from the pointwise layer is written linearly to the activation buffer 210. That is, the data is written in a linear sequence beginning at a base index (e.g., zero) and incrementing until the buffer has been filled. In one aspect, when the buffer is filled, the writing pointer wraps around to the beginning of the buffer. In some aspects, the write pointer is controlled by the DPP 204 or the CIM 202 (indicated by the arrow 226). In other aspects, the write pointer is controlled by a controller 208.

In some aspects, the controller 208 is a finite state machine (FSM). In other aspects, the controller 208 may be a programmable controller executing code or microcode. Generally, the controller 208 may be implemented using hardware (e.g., an application specific intergrated circuit (ASIC)), software, or a combination of hardware and software.

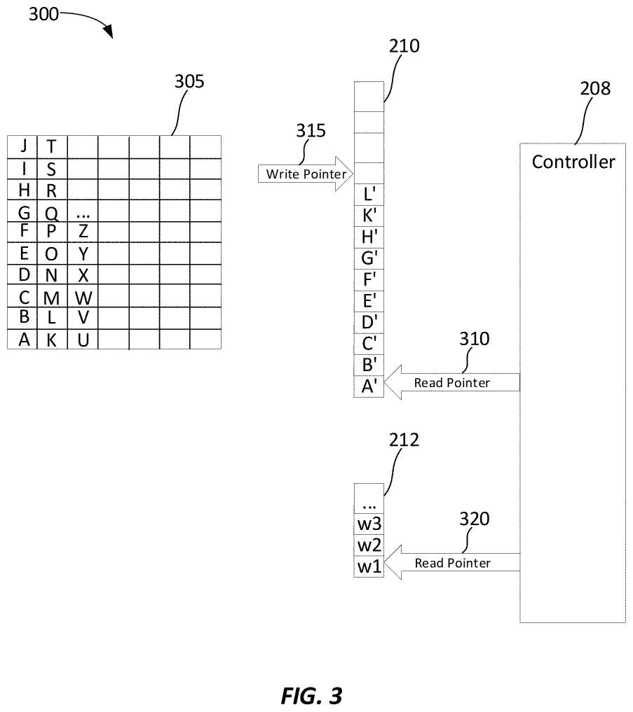

As illustrated, the controller 208 controls the read pointer (indicated by arrow 230) for the activation buffer 210. Generally, data is read from the activation buffer 210 in a nonlinear manner. That is, the data may be read non-sequentially (e.g., skipping some elements in the activation buffer 210), as controlled by the read pointer. In some aspects, the controller 208 controls the read pointer to selectively read patches of data from the input tensor, as described in more detail below with reference to FIG. 3. The activation data read from the activation buffer 210 is provided to a MAC unit 214, as indicated by arrow 206. Specifically, the activation data is provided to a multiplier 215 of the MAC unit 214.

Additionally, a weight buffer 212 is used to store the appropriate weights (e.g., learned during training) for the depthwise convolution. In one aspect, the weight buffer 212 maintains weights learned for one or more convolution kernels, where each weight corresponds to a particular position on the kernel. For example, for a 3×3 kernel, the weight buffer 212 may store the nine weights—one for each position in the kernel.

As illustrated, the controller 208 can also control the reading of weights from the weight buffer 212 via a weight read pointer (indicated by arrow 232). The weights read from the weight buffer 212 are similarly provided to the multiplier 215 of the MAC unit 214.

By controlling the activation read pointer and weight read pointer, the controller 208 can iteratively provide an activation data element and a corresponding weight value to the multiplier 215. That is, for each element of activation data, the system can retrieve the corresponding weight associated with the appropriate position in the kernel that is being convolved with the activations. Although an iterative process is described for conceptual clarity, in some aspects, some or all of the activation data elements and weight values can be processed (e.g., multiplied) in parallel (e.g., using multiple MAC units).

As illustrated, the multiplier 215 can multiply the activation data and weight, providing the result to an adder 216 that adds it to the current running total for the depthwise operation (received from an accumulator register 217). As illustrated, the resulting sum is then stored in the accumulator register 217, and also returned as input to the adder 216 to be added to the next input (based on the next activation data element and weight). When the MAC unit 214 has finished operating on a given data patch, the result is provided to a downstream processing block 218 and the accumulator register 217 can be cleared.

In the illustrated aspect, the controller 208 can control the operations of the MAC unit 214 (e.g., multiplying the inputs, adding it to the total, and clearing the accumulator), as indicated by the arrow 234.

In some aspects, the controller 208 is programmable using configurable variables or registers defining how the data is read from the buffers and processed by the MAC unit 214. That is, the controller 208 may use one or more user-defined variables (e.g., register values) to control the way data is read from the activation buffer 210 and weight buffer 212, and when the MAC unit 214 computes a sum and clears the accumulator register 217, thereby controlling how the depthwise operation is performed. For example, differing values may be used depending on whether the depthwise operation uses 3×3 kernels, 5×5 kernels, and the like.

In one aspect, the configurable variables are used to access m blocks of data, each including n bytes, and each separated k bytes apart. That is, the controller 208 may include a variable indicating a size of the patch of activation data (e.g., 3×3), a variable indicating a size of each data element within the patch, and a variable indicating the spacing between the data elements and/or between patches in the activation buffer 210.

Using the configurable variables, the controller 208 can sequence through size-configurable CIM outputs (9 outputs for each application of a 3×3 kernel) in order to compute a digital MAC output for the input patch. The accumulator register 217 can then be cleared in preparation for the next patch of input data (e.g., as the kernel is strided across the input).

Advantageously, the DMAC 206 does not require any remote memory access to fetch data. Instead, the output of the CIM 202 is provided directly to the DMAC 206 and stored temporarily in the activation buffer 210, thereby eliminating any memory bottleneck.

Additionally, in some aspects, the DMAC operations can be pipelined behind the CIM operations to further reduce latency and increase efficiency and throughput. That is, the DMAC 206 may begin processing data from the CIM 202 upon determining that some particular data element is ready and has been written to the activation buffer 210 (e.g., the last data element in a given patch of data). While the DMAC 206 processes this current patch, the CIM 202 can continue to prepare the next data element(s) needed for the next patch(es).

In the illustrated aspect, the output of the MAC unit 214 is provided to a processing block 218 that can optionally perform any other pre or post processing operations on the data before it is provided to a subsequent layer in the network. For example, the processing block 218 may perform pre-scaling, post-scaling, and the like. Similarly, in some aspects, the processing block 218 can provide the nonlinearity of the layer (e.g., processing the data using a nonlinear activation function). Generally, the processing block 218 is an optional component that may not be present in all aspects.

The resulting output can then be provided as output from the DMAC 206. In the illustrated aspect, a multiplexer 220 can be used to select whether the output of the layer is based on the MAC unit 214, or if the output of the DPP 204 (indicated by arrow 224) bypasses the DMAC 206 and is provided directly as output to the next layer. That is, the multiplexer 220 can be used to control whether the DMAC 206 is used (and depthwise convolutions are performed) or not. Generally, the multiplexer 220 is an optional component that may not be present in all aspects. In various aspects, the multiplexer 220 may be controller by the controller 208, or by a component external to the system 200. In at least one aspect, the multiplexer 220 is controlled by a fixed control/status register (CSR) block.

Although a single DMAC 206 is illustrated for conceptual clarity, there may be a separate DMAC 206 for each channel in the data output by the CIM(s) 202. For example, if the input data to the depthwise operation (e.g., the tensor 115 in FIG. 1), has 32 channels, the CIM 202 output may be provided to 32 separate DMACs 206. In at least one aspect, the system 200 may be configured to share a single DMAC 206 for two or more channels. Using the techniques described herein, the CIM 202 generally requires more time than the DMAC 206 to process its respective input data. Thus, if two or more channels both share the DMAC 206 for output, the stall or delay between them may be hidden behind the relatively larger latency of the CIM 202, and both may finish within the operation time of the CIM 202.

Advantageously, in some aspects, the controller 208 may be shared across any number of DMACs 206. That is, the pointers generated and controlled by the controller 208 may be used to control any number of DMACs 206 in parallel.

In some aspects, the system can optionally detect sparsity in the output of the CIM 202 (e.g., the percentage of values that are zero, or the percentage of non-zero values), and bypass the DMAC 206. That is, if the pointwise operation results in a tensor that satisfies sparsity criteria, then the system may refrain from writing the activation data to the activation buffer 210 and/or refrain from processing the data using the DMAC 206. For example, if the input activation data or the weight values are sufficiently sparse, then the resulting output is likely to be close to zero. Thus, in one aspect, the system may simply output a zero and bypass the DMAC 206. This can improve the efficiency of the system by preserving computational resources and energy that need not be spent.

### Example Process to Read and Write Activation Data in a DMAC

FIG. 3 depicts an example process to efficiently read and write activation data, from a CIM, to and from an activation buffer in order to perform depthwise convolutions.

In the illustrated aspect, the data input to the CIM array for a single channel is illustrated in block 305. As illustrated, this input can be represented as a multidimensional tensor of activation data. That is, although the illustrated aspect depicts a two-dimensional tensor for conceptual clarity (representing a single channel of data), the input may be a tensor with any number of channels. Stated differently, each data element in the block 305 may in fact correspond to a set of data elements across all channels of the tensor. As discussed above, the CIM generally computes output data element by data element (e.g., pixel by pixel) across channels based on the input 305. As illustrated, the input data includes data elements A-Z, arranged in an array.

In a depthwise-separable convolution operation, a CIM may be used to perform the pointwise operations. Generally, the CIM array processes each data element to compute a pointwise convolution across the channels of input data. That is, for each data element in the block 305, the CIM will output a corresponding pointwise convolution based on that data element (across all channels of input data in the given spatial location). For example, for the data element labeled “A” in the block 305, the CIM will compute a pointwise operation on data element “A” across the channels, outputting a corresponding value in the same position of the tensor.

For conceptual clarity, the illustrated example depicts similar data element labels in the activation buffer 210. That is, for the input data elements “A” (spanning multiple channels) in block 305, the activation buffer 210 is depicted as containing data element “A′.” It is to be understood that the data element “A′” in the activation buffer 210 is the result of a pointwise operation (performed by a CIM) on the data elements indicated by “A” (across all channels) in the input 305.

To compute a depthwise convolution for the data output by the CIM, a kernel is applied to a patch of data in the block (e.g., a 3×3 patch). The kernel can then be strided across the data to a new patch of data elements. For example, the depthwise convolution may be performed by computing a first result for a first patch (e.g., data elements A′, B′, C′, K′, L′, M′, U′, V′, and W′). As discussed above, applying the kernel for this patch can include writing data elements to the activation buffer 210 linearly as they are generated by the CIM, and reading them nonlinearly to select the particular patch. The DMAC can then iterate through the data elements, multiplying each by the corresponding weight indicated by the kernel, to generate a result. The next patch of data (e.g., B′, C′, D′, L′, M′, N′, V′, W′, and X′, if a stride of one is used) can then be read and used to compute the next output.

In the illustrated aspect, the controller 208 controls the read pointer 310 that is used to selectively read data from the activation buffer 210 for processing with the MAC unit. The write pointer 315 may be controlled by the controller 208, or by another component (such as a DPP). Generally, the activation data elements are written to the activation buffer 210 sequentially as indicated by the labels A-Z.

As illustrated, the write pointer 315 moves linearly through the activation buffer 210 to write data elements from the CIM. In some aspects, the system uses a process referred to as tearing to divide the data (in the block 305, and/or in the activation buffer 310) in order to improve space efficiency of the activation buffer 210. The system may divide the activation data based on a configuration or size of the activation buffer 210. The data may then be processed by the CIM and written by linearly writing data elements until a division or partition is reached. One or more data elements can then be skipped (e.g., not processed by the CIM and not written into the activation buffer 210), and additional elements after the partition can be written to the buffer.

For example, suppose the activation buffer is 32 bytes long. If the input tensor (the activation data to the CIM) is 64 bytes by 64 bytes, then the activation buffer will be filled with elements from the first column of the activation data, preventing any depthwise convolutions from being performed. That is, the activation buffer 210 will fill with values of the pointwise convolutions for elements A-J (convolved values A′ through J′ in the activation buffer 210) in the illustrated aspect, and have no room for values generated based on elements K, L, and M, (resulting in convolved values K′, L′, and M′) which are needed for the first depthwise convolution.

Thus, in one aspect, the system tears or divides the input data tensor based on the size of the activation buffer 210, and/or based on the size of the depthwise convolution kernel. For example, if the activation buffer 210 is 32 bytes long, then the system may tear the input activations to a height of eight. This allows data from four columns of the activation data to be written to the buffer, allowing depthwise convolutions to be performed.

This is reflected in the illustrated aspect, where the activation buffer 210 includes data elements A-H, skips elements I and J, and includes elements K and L. The system can then continue to write further elements M through R, where it reaches another divide and skips to element U.

In some aspects, as soon as the last element needed for the first depthwise operation is available in the activation buffer 110, the controller 208 can initiate the DMAC. For example, for a 3×3 kernel, the DMAC may begin when the data element W is written to the activation buffer 210.

While the DMAC is operating on this patch, then, the CIM may continue to generate and output data elements (e.g., element X, followed by Y, and so on), which are written linearly to the activation buffer 210. Because the DMAC may be pipelined behind the CIM, as soon as the first patch is complete, the DMAC can begin reading the next patch from the activation buffer 210 (e.g., elements B, C, D, L, M, N, V, W, and X).

As discussed above, to read a given data patch, the controller 208 can control the read pointer 310 to read nonlinearly from the activation buffer 210. In the illustrated example, for the first patch, the controller 208 causes the read pointer 310 to point to data element A, increments it to point to data element B, and increments it to point to data element C. Then, the controller 208 causes the read pointer 310 to skip a defined number of elements (which may be defined based in part on the tearing criteria and/or the kernel size), such that data element K is read next.

In parallel, the controller 208 controls the read pointer 320 for the weight buffer 212, such that the weight indicated by the read pointer 320 corresponds to the activation data indicated by the read pointer 310.

In some aspects, this partitioning of the input data may result in some extra overhead to compute the depthwise convolutions across multiple partitions. For example, when a 3×3 kernel reaches elements G, H, and I, the system may need to re-compute element I (as it was not written to the activation buffer 210). Alternatively, if G and H have already been overwritten (e.g., as I and subsequent values were added to the buffer for the next partition), the system may re-compute G and H.

In some aspects, therefore, the system may use more intelligent control of the write pointer 315 to retain the overlap and avoid overwriting such data elements that will be needed for future convolutions. This can reduce or eliminate the overhead introduced by the partitioning. For example, in one aspect, the system can ensure that such boundary data (written during one buffer write and needed for both the current partition and the subsequent partition) is not overwritten by the next buffer write. In another aspect, the system can increment the read pointer by a defined offset when starting a new partition, in order to retain the overlapping data elements. In some aspects, the system can delay the wraparound of the write pointer to preserve values in the buffer. For example, after writing a partition to the activation buffer 210, the controller 208 can allow the write pointer 315 to continue incrementing for another N values before wrapping it back to zero (thereby preserving N values from a previous partition in the buffer).

Relatedly, in some aspects, increasing the size of the activation buffer 210 can reduce the overhead introduced by partitioning, but with the tradeoff of additional cost of the DMAC.

### Example Method for Efficient Depthwise Convolutions Using a DMAC

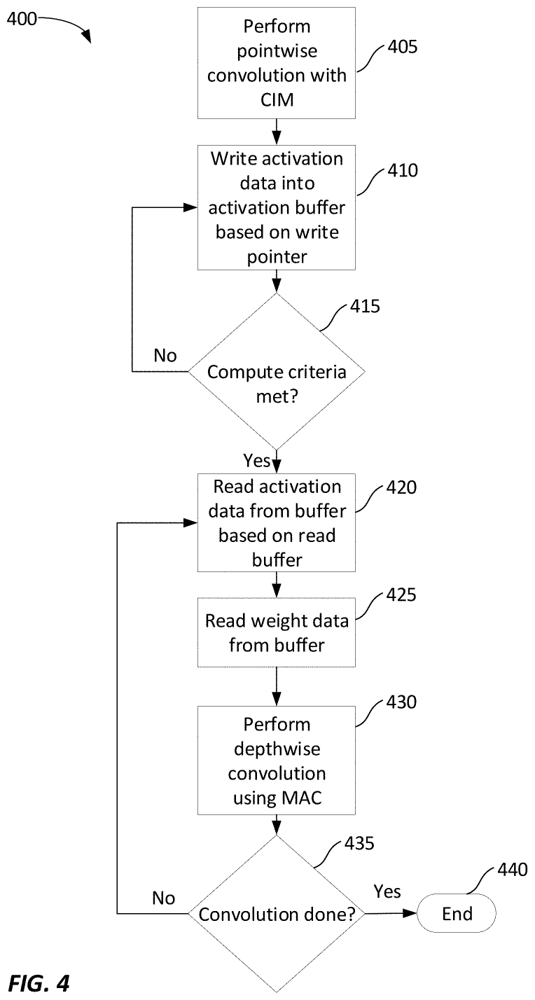

FIG. 4 is an example flow diagram illustrating a method 400 for efficiently performing depthwise convolutions using near-CIM digital MAC engines. In some aspects, the method 400 is used to perform a depthwise convolution after a pointwise convolution is performed using a CIM.

The method 400 begins at block 405, where a processing system performs a pointwise convolution using a CIM array. As discussed above, CIM arrays can generally be used to efficiently perform pointwise convolutions at least in part due to the large number of multiply-accumulate operations required. In contrast, depthwise convolutions typically require fewer multiply-accumulate operations, preventing efficient use of a CIM.

At block 410, the activation data of the pointwise operation (output by the CIM) is written to an activation buffer for a DMAC, based on a write pointer. In some aspects, as discussed above, a respective DMAC (with a respective activation buffer) may be used for each respective channel in the activation data.

In at least one aspect, the processing system may share a DMAC between two or more channels of activation data. For example, the processing system may perform depthwise convolutions for a first channel using the DMAC, and subsequently re-use the DMAC to perform depthwise convolutions on a second channel. As the CIM may introduce more latency than the DMAC, this sequential re-use may cause little or no additional latency in some aspects.

In some aspects, prior to writing to the buffer of the DMAC, the processing system can determine whether the activation data, the weights of the model, or both satisfy one or more defined sparsity criteria. For example, if the activation data (output by the CIM) or the weights are sufficiently sparse, the processing system may decide to refrain from writing it to the activation buffer (or to refrain from using the DMAC from processing any data that has already been written), because the resulting output of the depthwise convolution is likely to be small. In one aspect, the processing system may therefore bypass the depthwise convolution and use a zero as output from the depthwise layer.

In aspects of the present disclosure, writing the activation data is generally performed in a linear manner. That is, the activation data can be written sequentially into adjacent locations in the activation buffer (e.g., adjacent indices). When the last location/index is reached, the write pointer may wrap around to the first index to begin overwriting the old activation data.

In some aspects, writing activation data to the buffer includes tearing or partitioning the input CIM data, as discussed above. For example, the processing system may partition, delineate, or divide (also referred to as tearing) the tensor or matrix of activation data based on the size of the activation buffer, based on the size of the depthwise convolution kernel(s), and the like. This can allow the activations to be effectively packed into the activation buffer in way that facilitates the depthwise convolution process (e.g., by ensuring that all the needed data elements for a given depthwise convolution can be present in the buffer). Generally, such partitioning involves writing a first set of data elements to the buffer (e.g., the resulting values of pointwise convolutions on elements A-H in FIG. 2), bypassing a next set of elements (e.g., refraining from computing pointwise convolutions for elements I and J in FIG. 2), and writing a subsequent set of elements (e.g., the resulting values of pointwise convolutions beginning with element L in FIG. 2).

After writing one or more activation data elements to the buffer, the method 400 continues to block 415, where the processing system determines whether one or more compute criteria are satisfied. For example, the processing system may determine whether a flag or other instruction has been received (e.g., from a controller). In some aspects, the processing system initiates the depthwise computation upon determining that a given data element is available in the buffer. For example, when the last data element needed for the first depthwise convolution has been written, the processing system may determine that the compute criteria are satisfied.

If the criteria are not satisfied, the method 400 returns to block 410 to continue writing activation data to the activation buffer. If, at block 415, the processing system determines that the compute criteria are satisfied, the method 400 continues to block 420.

At block 420, to initiate the depthwise convolution, the processing system reads an activation data element from the buffer, based on an activation read pointer. In some aspects, the read pointer is controlled by a controller, as discussed above. Generally, the read pointer can move in a nonlinear manner. That is, the processing system may read activation data from the buffer nonlinearly (e.g., reading one or more data elements, skipping one or more next elements in the buffer, and reading one or more subsequent elements). This nonlinear reading enables the processing system to efficiently retrieve the data needed for any given depthwise convolution, as discussed above.

The activation data can be read from the buffer and provided as input to a multiplier, as discussed above. For example, the processing system may sequentially read activation data to a MAC, which processes it to generate an output for the depthwise convolution.

At block 425, the processing system can read a weight data element from a weight buffer, as discussed above. This process may be performed linearly (e.g., reading adjacent elements sequentially), or nonlinearly. Generally, for each activation data element read from the activation buffer, the processing system reads the corresponding weight from the weight buffer. For example, if the activation data element is at the center of the depthwise kernel that is currently being applied, the processing system can retrieve the weight associated with this center position in the kernel.

After an activation data element and a weight have been read from the corresponding buffers, the method 400 continues to block 430, where the processing system performs a depthwise convolution using a MAC, as discussed above. For example, the processing system may multiply the weight and activation data, and add the product to a running total (e.g., using an adder and/or accumulator) for the convolution.

The method 400 then continues to block 435, where the processing system determines whether the convolution has been completed. For example, based on a configuration of the controller (e.g., a user-specified kernel size or number of iterations for each convolution), the processing system can determine whether additional data elements remain for the current convolution, or if all needed elements have been processed.

If application of the kernel has been completed, the method 400 ends at block 440. If additional elements remain, the method 400 returns to block 420 to select the next activation data element, as discussed above.

In this way, the processing system can efficiently perform depthwise convolutions using the activation buffer. In some aspects, the processing system can proceed to repeat the method 400 for the next set of activation data elements (e.g., the next patch of activation data, after the kernel is slid or strided across the activation tensor). As additional data is written to the activation buffer, the processing system can continue this process to perform depthwise convolution for the entirety of the activation data.

### Example Method for Efficient Depthwise Convolution Operations

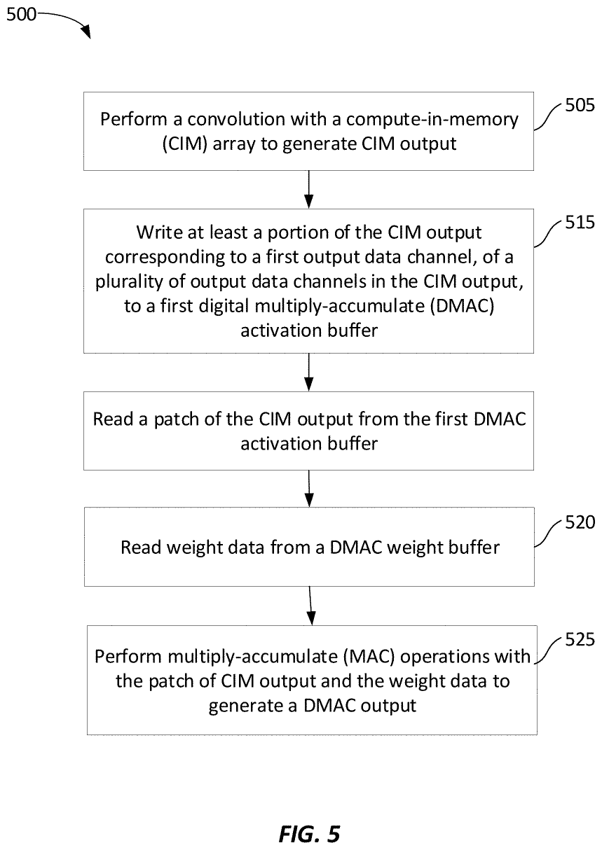

FIG. 5 is an example flow diagram illustrating a method 500 for efficiently performing depthwise convolutions.

The method 500 begins at block 505, a convolution is performed with a compute-in-memory (CIM) array to generate CIM output.

At block 510, the at least a portion of the CIM output corresponding to a first output data channel, of a plurality of output data channels in the CIM output, is written to a first digital multiply-accumulate (DMAC) activation buffer.

At block 515, a patch of the CIM output is read from the first DMAC activation buffer.

In some aspects, the first DMAC activation buffer is tightly coupled to the CIM array by a dedicated path from the first output data channel to the first DMAC activation buffer.

In some aspects, writing the CIM output to the first DMAC activation buffer comprises: partitioning input data to the CIM based on a configuration of the first DMAC activation buffer, and selectively writing the CIM output to the first DMAC activation buffer based on the partitioning.

In some aspects, selectively writing the CIM output to the first DMAC activation buffer based on the partitioning comprises: writing a first data element for a first partition to the first DMAC activation buffer, and retaining the first data element in the first DMAC activation buffer when writing data elements for a second partition.

In some aspects, selectively writing the CIM output to the first DMAC activation buffer comprises: writing a first set of data elements from the CIM output to the first DMAC activation buffer in a linear manner, upon reaching a boundary of a partition in the CIM output, bypassing a second set of data elements in the CIM output, and writing a third set of data elements from the CIM output to the first DMAC activation buffer in a linear manner.

At block 520, weight data is read from a DMAC weight buffer.

In some aspects, reading the patch of CIM output from the first DMAC activation buffer is performed non-linearly and comprises: reading a first data element from the first DMAC activation buffer, and reading a second data element from the first DMAC activation buffer, wherein the second data element is not adjacent to the first data element in the first DMAC activation buffer.

In some aspects, wherein writing CIM output to the first DMAC activation buffer and reading the patch of CIM output from the first DMAC activation buffer are controlled by a programmable controller.

In some aspects, the programmable controller implements a read pointer and a write pointer, and the read pointer and write pointer are shared across a plurality of DMAC activation buffers, each associated with a respective output data channel of the plurality of output data channels.

In some aspects, the programmable controller is programmed using one or more configurable variables comprising: a first variable indicating a size of the patch of activation data, a second variable indicating a size of each data element in the patch of CIM output, and a third variable indicating a spacing of data elements in the activation buffer.

At block 525, multiply-accumulate (MAC) operations are performed with the patch of CIM output and the weight data to generate a DMAC output.

In some aspects, the method 500 also includes generating a depthwise convolution output based on DMAC output for each respective output data channel of the plurality of output data channels.

In some aspects, performing the MAC operations with the patch of CIM output and the weight data is pipelined behind the CIM array by initiating the MAC operations upon determining that a specified data element has been written to the first DMAC activation buffer.

In some aspects, the method 500 also includes, for a second output data channel of the plurality of output data channels: determining that a patch of data in the second output data channel satisfies defined sparsity criteria, and refraining from processing the patch of data using a DMAC.

### Example Processing System for Efficient Depthwise Convolutions

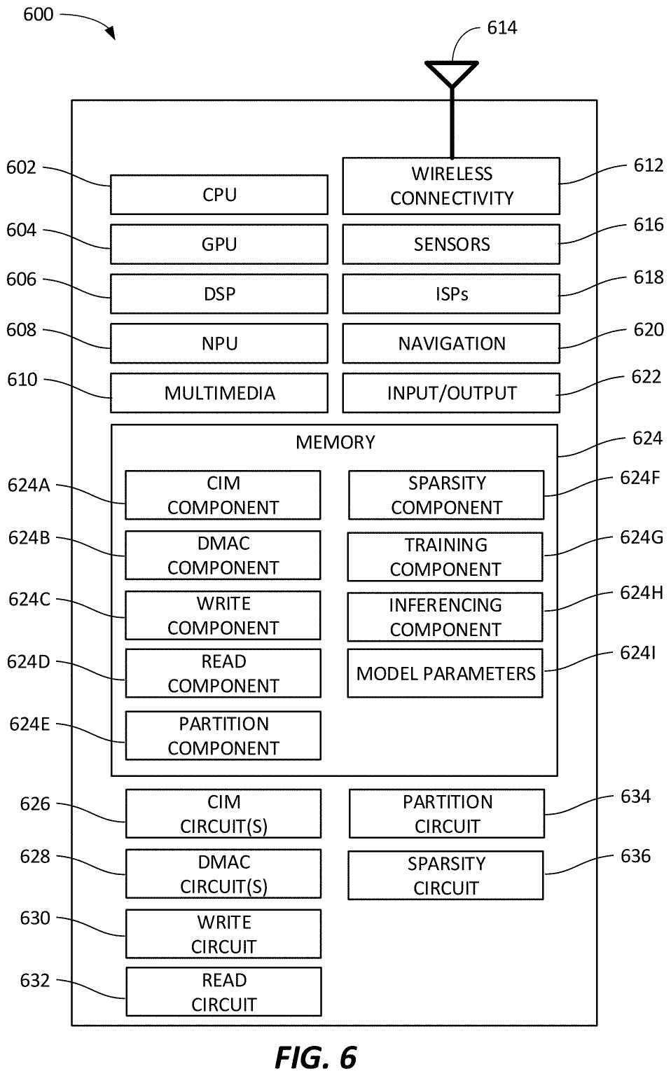

FIG. 6 depicts an example processing system 600 for performing efficient depthwise convolution, such as described herein for example with respect to FIGS. 1-5.

Processing system 600 includes a central processing unit (CPU) 602, which in some examples may be a multi-core CPU. Instructions executed at the CPU 602 may be loaded, for example, from a program memory associated with the CPU 602 or may be loaded from a memory partition 624.

Processing system 600 also includes additional processing components tailored to specific functions, such as a graphics processing unit (GPU) 604, a digital signal processor (DSP) 606, a neural processing unit (NPU) 608, a multimedia processing unit 610, and a wireless connectivity component 612.

An NPU, such as 608, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 608 is a part of one or more of CPU 602, GPU 604, and/or DSP 606.

In some examples, wireless connectivity component 612 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 612 is further connected to one or more antennas 614.

Processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

Processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

Processing system 600 also includes memory 624, which is representative of one or more static and/or dynamic memories, such as a dynamic random access memory, a flash-based static memory, and the like. In this example, memory 624 includes computer-executable components, which may be executed by one or more of the aforementioned processors of processing system 600.

In particular, in this example, memory 624 includes CIM component 624A, DMAC component 624B, write component 624C, read component 624D, partition component 624E, sparsity component 624F, training component 624F, inferencing component 624H, and model parameters 6241. The depicted components, and others not depicted, may be configured to perform various aspects of the methods described herein.

Processing system 600 further comprises CIM circuit 626, such as described above, for example, with respect to FIGS. 1-5.

Processing system 600 further comprises DMAC circuit 628, such as described above with respect to FIGS. 1-5.

Processing system 600 further comprises write circuit 630, such as described above, for example, with respect to FIGS. 1-5.

Processing system 600 further comprises read circuit 632, such as described above, for example, with respect to FIGS. 1-5.

Processing system 600 further comprises partition circuit 634, such as described above, for example, with respect to FIGS. 3-5.

Processing system 600 further comprises sparsity circuit 636, such as described above, for example, with respect to FIGS. 2, 4, and 5.

Though depicted as separate circuit for clarity in FIG. 6, circuits 626, 628, 630, 632, 634, and 636 may collectively or individually be implemented in other processing devices of processing system 600, such as within CPU 602, GPU 604, DSP 606, NPU 608, and the like.

Generally, processing system 600 and/or components thereof may be configured to perform the methods described herein.

Notably, in other embodiments, aspects of processing system 600 may be omitted, such as where processing system 600 is a server computer or the like. For example, multimedia component 610, wireless connectivity 612, sensors 616, ISPs 618, and/or navigation component 620 may be omitted in other embodiments. Further, aspects of processing system 600 maybe distributed between multiple devices.

The depicted components, and others not depicted, may be configured to perform various aspects of the methods described herein.

### Example Clauses

Clause 1: A method, comprising: performing a convolution with a compute-in-memory (CIM) array to generate CIM output; writing at least a portion of the CIM output corresponding to a first output data channel, of a plurality of output data channels in the CIM output, to a first digital multiply-accumulate (DMAC) activation buffer; reading a patch of the CIM output from the first DMAC activation buffer; reading weight data from a DMAC weight buffer; and performing multiply-accumulate (MAC) operations with the patch of CIM output and the weight data to generate a DMAC output.

Clause 2: The method according to Clause 1, further comprising generating a depthwise convolution output based on DMAC output for each respective output data channel of the plurality of output data channels.

Clause 3: The method according to any one of Clauses 1-2, wherein performing the MAC operations with the patch of CIM output and the weight data is pipelined behind the CIM array by initiating the MAC operations upon determining that a specified data element has been written to the first DMAC activation buffer.

Clause 4: The method according to any one of Clauses 1-3, wherein writing the CIM output to the first DMAC activation buffer comprises: partitioning input data to the CIM based on a configuration of the first DMAC activation buffer; and selectively writing the CIM output to the first DMAC activation buffer based on the partitioning.

Clause 5: The method according to any one of Clauses 1-4, wherein selectively writing the CIM output to the first DMAC activation buffer based on the partitioning comprises: writing a first data element for a first partition to the first DMAC activation buffer; and retaining the first data element in the first DMAC activation buffer when writing data elements for a second partition.

Clause 6: The method according to any one of Clauses 1-5, wherein selectively writing the CIM output to the first DMAC activation buffer comprises: writing a first set of data elements from the CIM output to the first DMAC activation buffer in a linear manner; upon reaching a boundary of a partition in the CIM output, bypassing a second set of data elements in the CIM output; and writing a third set of data elements from the CIM output to the first DMAC activation buffer in a linear manner.

Clause 7: The method according to any one of Clauses 1-6, wherein reading the patch of CIM output from the first DMAC activation buffer is performed non-linearly and comprises: reading a first data element from the first DMAC activation buffer; and reading a second data element from the first DMAC activation buffer, wherein the second data element is not adjacent to the first data element in the first DMAC activation buffer.

Clause 8: The method according to any one of Clauses 1-7, wherein writing CIM output to the first DMAC activation buffer and reading the patch of CIM output from the first DMAC activation buffer are controlled by a programmable controller.

Clause 9: The method according to any one of Clauses 1-8, wherein: the programmable controller implements a read pointer and a write pointer; and the read pointer and write pointer are shared across a plurality of DMAC activation buffers, each associated with a respective output data channel of the plurality of output data channels.

Clause 10: The method according to any one of Clauses 1-9, wherein the programmable controller is programmed using one or more configurable variables comprising: a first variable indicating a size of the patch of CIM output; a second variable indicating a size of each data element in the patch of CIM output; and a third variable indicating a spacing of data elements in the activation buffer.

Clause 11: The method according to any one of Clauses 1-10, further comprising, for a second output data channel of the plurality of output data channels: determining that a patch of data in the second output data channel satisfies defined sparsity criteria; and refraining from processing the patch of data using a DMAC.

Clause 12: The method according to any one of Clauses 1-11, wherein the first DMAC activation buffer is tightly coupled to the CIM array by a dedicated path from the first output data channel to the first DMAC activation buffer.

Clause 13: A method, comprising: performing a convolution with a compute-in-memory (CIM) array to generate CIM output; processing the CIM output to generate a plurality of output data channels; and for a first output data channel of the plurality of output data channels: writing activation data to a first digital multiply-accumulate (DMAC) activation buffer associated with the first output data channel, wherein each respective output data channel is associated with a respective DMAC activation buffer; reading a patch of activation data from the first DMAC activation buffer; reading weight data from a DMAC weight buffer associated with the first output data channel; and performing multiply-accumulate (MAC) operations with the patch of activation data and the weight data to generate a DMAC output.

Clause 14: A system, comprising: a memory comprising computer-executable instructions; and one or more processors configured to execute the computer-executable instructions and cause the processing system to perform a method in accordance with any one of Clauses 1-13.

Clause 15: A system, comprising means for performing a method in accordance with any one of Clauses 1-13.

Clause 16: A non-transitory computer-readable medium comprising computer-executable instructions that, when executed by one or more processors of a processing system, cause the processing system to perform a method in accordance with any one of Clauses 1-13.

Clause 17: A computer program product embodied on a computer-readable storage medium comprising code for performing a method in accordance with any one of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term “connected to”, in the context of sharing electronic signals and data between the elements described herein, may generally mean in data communication between the respective elements that are connected to each other. In some cases, elements may be directly connected to each other, such as via one or more conductive traces, lines, or other conductive carriers capable of carrying signals and/or data between the respective elements that are directly connected to each other. In other cases, elements may be indirectly connected to each other, such as via one or more data busses or similar shared circuitry and/or integrated circuit elements for communicating signals and data between the respective elements that are indirectly connected to each other.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
performing a convolution with a compute-in-memory (CIM) array to generate CIM output;
writing at least a portion of the CIM output corresponding to a first output data channel, of a plurality of output data channels in the CIM output, to a first digital multiply-accumulate (DMAC) activation buffer;
reading a patch of the CIM output from the first DMAC activation buffer;
reading weight data from a DMAC weight buffer; and
performing multiply-accumulate (MAC) operations with the patch of CIM output and the weight data to generate a DMAC output.

2. The method of claim 1, further comprising generating a depthwise convolution output based on DMAC output for each respective output data channel of the plurality of output data channels.

3. The method of claim 1, wherein performing the MAC operations with the patch of CIM output and the weight data is pipelined behind the CIM array by initiating the MAC operations upon determining that a specified data element has been written to the first DMAC activation buffer.

4. The method of claim 1, wherein writing the CIM output to the first DMAC activation buffer comprises:
partitioning input data to the CIM based on a configuration of the first DMAC activation buffer; and
selectively writing the CIM output to the first DMAC activation buffer based on the partitioning.

5. The method of claim 4, wherein selectively writing the CIM output to the first DMAC activation buffer based on the partitioning comprises:
writing a first data element for a first partition to the first DMAC activation buffer; and
retaining the first data element in the first DMAC activation buffer when writing data elements for a second partition.

6. The method of claim 4, wherein selectively writing the CIM output to the first DMAC activation buffer comprises:
writing a first set of data elements from the CIM output to the first DMAC activation buffer in a linear manner;
upon reaching a boundary of a partition in the CIM output, bypassing a second set of data elements in the CIM output; and
writing a third set of data elements from the CIM output to the first DMAC activation buffer in a linear manner.

7. The method of claim 4, wherein reading the patch of CIM output from the first DMAC activation buffer is performed non-linearly and comprises:
reading a first data element from the first DMAC activation buffer; and
reading a second data element from the first DMAC activation buffer, wherein the second data element is not adjacent to the first data element in the first DMAC activation buffer.

8. The method of claim 1, wherein writing CIM output to the first DMAC activation buffer and reading the patch of CIM output from the first DMAC activation buffer are controlled by a programmable controller.

9. The method of claim 8, wherein:
the programmable controller implements a read pointer and a write pointer; and
the read pointer and write pointer are shared across a plurality of DMAC activation buffers, each associated with a respective output data channel of the plurality of output data channels.

10. The method of claim 8, wherein the programmable controller is programmed using one or more configurable variables comprising:
a first variable indicating a size of the patch of CIM output;
a second variable indicating a size of each data element in the patch of CIM output; and
a third variable indicating a spacing of data elements in the activation buffer.

11. The method of claim 1, further comprising, for a second output data channel of the plurality of output data channels:
determining that a patch of data in the second output data channel satisfies defined sparsity criteria; and
refraining from processing the patch of data using a DMAC.

12. The method of claim 1, wherein the first DMAC activation buffer is tightly coupled to the CIM array by a dedicated path from the first output data channel to the first DMAC activation buffer.

13. A non-transitory computer-readable medium comprising computer-executable instructions that, when executed by one or more processors of a processing system, cause the processing system to perform an operation, comprising:
performing a convolution with a compute-in-memory (CIM) array to generate CIM output;
writing at least a portion of the CIM output corresponding to a first output data channel, of a plurality of output data channels in the CIM output, to a first digital multiply-accumulate (DMAC) activation buffer;
reading a patch of the CIM output from the first DMAC activation buffer;
reading weight data from a DMAC weight buffer; and
performing multiply-accumulate (MAC) operations with the patch of CIM output and the weight data to generate a DMAC output.

14. The non-transitory computer-readable medium of claim 13, the operation further comprising generating a depthwise convolution output based on DMAC output for each respective output data channel of the plurality of output data channels.

15. The non-transitory computer-readable medium of claim 13, wherein performing the MAC operations with the patch of CIM output and the weight data is pipelined behind the CIM array by initiating the MAC operations upon determining that a specified data element has been written to the first DMAC activation buffer.

16. The non-transitory computer-readable medium of claim 13, wherein writing the CIM output to the first DMAC activation buffer comprises:
partitioning input data to the CIM based on a configuration of the first DMAC activation buffer; and
selectively writing the CIM output to the first DMAC activation buffer based on the partitioning.

17. The non-transitory computer-readable medium of claim 16, wherein selectively writing the CIM output to the first DMAC activation buffer comprises:
writing a first set of data elements from the CIM output to the first DMAC activation buffer in a linear manner;
upon reaching a boundary of a partition in the CIM output, bypassing a second set of data elements in the CIM output; and
writing a third set of data elements from the CIM output to the first DMAC activation buffer in a linear manner.

18. The non-transitory computer-readable medium of claim 16, wherein reading the patch of CIM output from the first DMAC activation buffer is performed non-linearly and comprises:
reading a first data element from the first DMAC activation buffer; and
reading a second data element from the first DMAC activation buffer, wherein the second data element is not adjacent to the first data element in the first DMAC activation buffer.

19. The non-transitory computer-readable medium of claim 13, wherein writing CIM output to the first DMAC activation buffer and reading the patch of CIM output from the first DMAC activation buffer are controlled by a programmable controller.

20. The non-transitory computer-readable medium of claim 19, wherein:
the programmable controller implements a read pointer and a write pointer; and
the read pointer and write pointer are shared across a plurality of DMAC activation buffers, each associated with a respective output data channel of the plurality of output data channels.

21. The non-transitory computer-readable medium of claim 19, wherein the programmable controller is programmed using one or more configurable variables comprising:
a first variable indicating a size of the patch of CIM output;
a second variable indicating a size of each data element in the patch of CIM output; and
a third variable indicating a spacing of data elements in the activation buffer.

22. The non-transitory computer-readable medium of claim 13, the operation further comprising, for a second output data channel of the plurality of output data channels:
determining that a patch of data in the second output data channel satisfies defined sparsity criteria; and
refraining from processing the patch of data using a DMAC.

23. A system, comprising:
a memory comprising computer-executable instructions;
one or more processors configured to execute the computer-executable instructions and cause the system to perform an operation comprising:
performing a convolution with a compute-in-memory (CIM) array to generate CIM output;
writing at least a portion of the CIM output corresponding to a first output data channel, of a plurality of output data channels in the CIM output, to a first digital multiply-accumulate (DMAC) activation buffer;
reading a patch of the CIM output from the first DMAC activation buffer;
reading weight data from a DMAC weight buffer; and
performing multiply-accumulate (MAC) operations with the patch of CIM output and the weight data to generate a DMAC output.

24. The system of claim 23, the operation further comprising generating a depthwise convolution output based on DMAC output for each respective output data channel of the plurality of output data channels.

25. The system of claim 23, wherein performing the MAC operations with the patch of CIM output and the weight data is pipelined behind the CIM array by initiating the MAC operations upon determining that a specified data element has been written to the first DMAC activation buffer.

26. The system of claim 23, wherein writing the CIM output to the first DMAC activation buffer comprises:
partitioning input data to the CIM based on a configuration of the first DMAC activation buffer; and
selectively writing the CIM output to the first DMAC activation buffer based on the partitioning.

27. The system of claim 26, wherein selectively writing the CIM output to the first DMAC activation buffer comprises:
writing a first set of data elements from the CIM output to the first DMAC activation buffer in a linear manner;
upon reaching a boundary of a partition in the CIM output, bypassing a second set of data elements in the CIM output; and
writing a third set of data elements from the CIM output to the first DMAC activation buffer in a linear manner.

28. The system of claim 26, wherein reading the patch of CIM output from the first DMAC activation buffer is performed non-linearly and comprises:
reading a first data element from the first DMAC activation buffer; and
reading a second data element from the first DMAC activation buffer, wherein the second data element is not adjacent to the first data element in the first DMAC activation buffer.

29. The system of claim 23, wherein writing CIM output to the first DMAC activation buffer and reading the patch of CIM output from the first DMAC activation buffer are controlled by a programmable finite state machine (FSM).

30. The system of claim 23, the operation further comprising, for a second output data channel of the plurality of output data channels:
determining that a patch of data in the second output data channel satisfies defined sparsity criteria; and
refraining from processing the patch of data using a DMAC.
